(19) United States
(12) Patent Application Publication
(10) Pub. No.: US 2026/0222846 A1
(43) Pub. Date: Jul. 30, 2026

(54) COMMUNICATION CONTROL METHOD, NETWORK APPARATUS, AND USER EQUIPMENT

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/630,849

(22) Filed: Mar. 27, 2026

Related U.S. Application Data
(63) Continuation of application No. PCT/JP2024/034574, filed on Sep. 27, 2024.

(30) Foreign Application Priority Data
Sep. 27, 2023 (JP) 2023-166496

(51) Int. Cl. H04W 24/02

(52) U.S. Cl. CPC H04W 24/02

(57) ABSTRACT

In one aspect, a communication control method is a communication control method in a mobile communication system. The communication control method includes transmitting, by a network apparatus to a user equipment, a predetermined operation execution condition indicating an execution condition of a predetermined operation for an AI/ML model. The communication control method further includes executing, by the user equipment, the predetermined operation for the AI/ML model without transmitting an execution request for the predetermined operation to the network apparatus, when the predetermined operation execution condition is satisfied. Furthermore, the predetermined operation includes an operation for the AI/ML model that is performed during a period from generation of the AI/ML model to termination thereof.

### RELATED APPLICATIONS

The present application is a continuation based on PCT Application No. PCT/JP2024/034574, filed on Sep. 27, 2024, which claims the benefit of Japanese Patent Application No. 2023-166496 filed on Sep. 27, 2023. The content of which is incorporated by reference herein in their entirety.

### TECHNICAL FIELD

The present disclosure relates to a communication control method, a network apparatus, and a user equipment.

### BACKGROUND

In recent years, in the Third Generation Partnership Project (3GPP) (registered trademark; the same applies hereinafter) that is a standardization project for mobile communication systems, applying an artificial intelligence (AI) technology, in particular, a machine learning (ML) technology to wireless communication (air interface) in a mobile communication system has been studied.

### CITATION LIST

### Non-Patent Literature

Non-Patent Document 1: RP-213599 “New SI: Study on Artificial Intelligence (AI)/Machine Learning (ML) for NR Air Interface”

### SUMMARY

A communication control method according to a first aspect is a communication control method in a mobile communication system. The communication control method includes transmitting, by a network apparatus to a user equipment, a predetermined operation execution condition indicating an execution condition of a predetermined operation for an AI/ML model. The communication control method further includes executing, by the user equipment, the predetermined operation for the AI/ML model without transmitting an execution request for the predetermined operation to the network apparatus, when the predetermined operation execution condition is satisfied. Furthermore, the predetermined operation includes an operation for the AI/ML model that is performed during a period from generation of the AI/ML model to termination thereof.

A network apparatus according to a second aspect is a network apparatus in a mobile communication system. The network apparatus includes a transmitter configured to transmit, to a user equipment, a predetermined operation execution condition indicating an execution condition of a predetermined operation for an AI/ML model. In the user equipment, the predetermined operation for the AI/ML model is executed without transmitting an execution request for the predetermined operation to the network apparatus, when the predetermined operation execution condition is satisfied. Furthermore, the predetermined operation includes an operation performed by the user equipment for the AI/ML model during a period from generation of the AI/ML model to termination thereof.

A user equipment according to a third aspect is a user equipment in a mobile communication system. The user equipment includes a receiver configured to receive, from a network apparatus, a predetermined operation execution condition indicating an execution condition of a predetermined operation for an AI/ML model. The user equipment further includes a controller configured to execute the predetermined operation for the AI/ML model without transmitting an execution request for the predetermined operation to the network apparatus, when the predetermined operation execution condition is satisfied. The predetermined operation includes an operation for the AI/ML model that is performed during a period from generation of the AI/ML model to termination thereof.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in the AI/ML technology according to the first embodiment.

FIG. 8 is a diagram illustrating an arrangement example of functional blocks of the AI/ML technology according to the first embodiment.

FIG. 9 is a diagram illustrating an operation example according to a first embodiment.

FIG. 10 is a diagram illustrating an arrangement example of functional blocks of the AI/ML technology according to the first embodiment.

FIG. 11 is a diagram illustrating an arrangement example of functional blocks of the AI/ML technology according to the first embodiment.

FIG. 12 is a diagram illustrating an arrangement example of functional blocks of the AI/ML technology according to the first embodiment.

FIG. 13 is a diagram illustrating an operation example according to the first embodiment.

FIG. 14 is a diagram illustrating an example of a configuration message according to the first embodiment.

FIG. 15 is a diagram illustrating a configuration example of functional blocks of the AI/ML technology according to the first embodiment.

FIG. 16 is a diagram illustrating an operation example according to the first embodiment.

FIG. 17 is a diagram illustrating an operation example according to a second embodiment.

### DESCRIPTION OF EMBODIMENTS

An object of the present disclosure is to suppress consumption of radio resources.

### First Embodiment

A mobile communication system according to a first embodiment will be described with reference to the drawings. In the description of the drawings, the same or similar parts are denoted by the same or similar reference signs.

### Configuration of Mobile Communication System

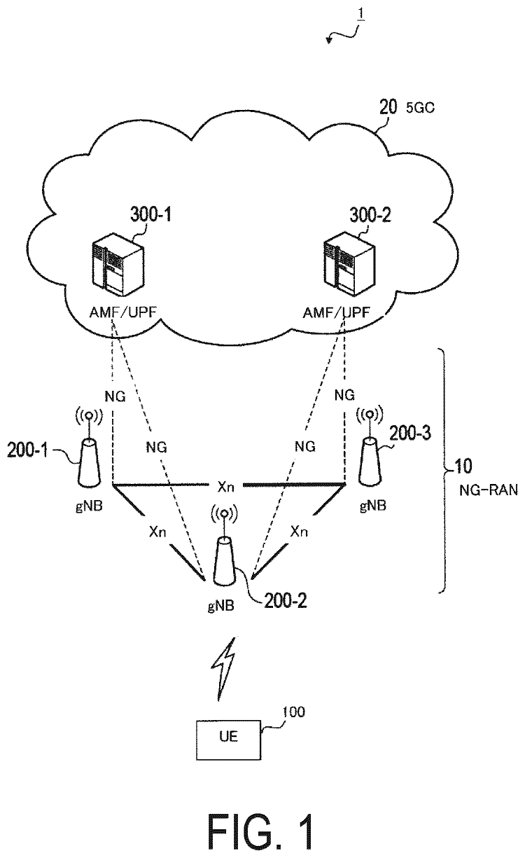

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface.

Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

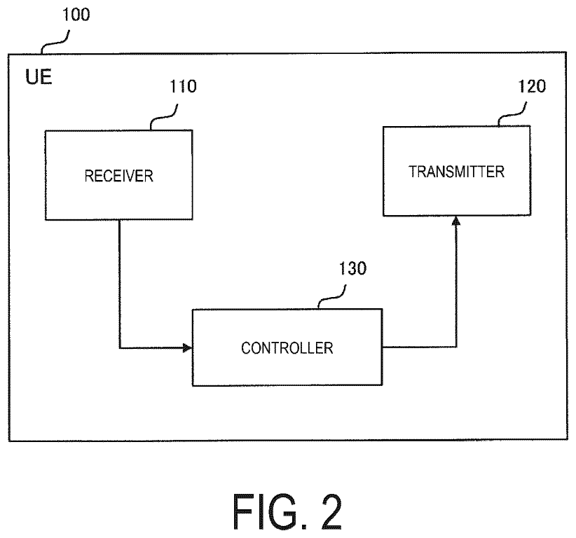

FIG. 2 is a diagram illustrating a configuration example of the user equipment (UE) 100 according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

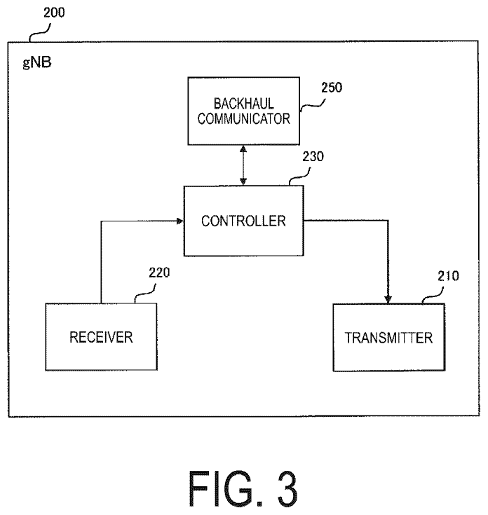

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

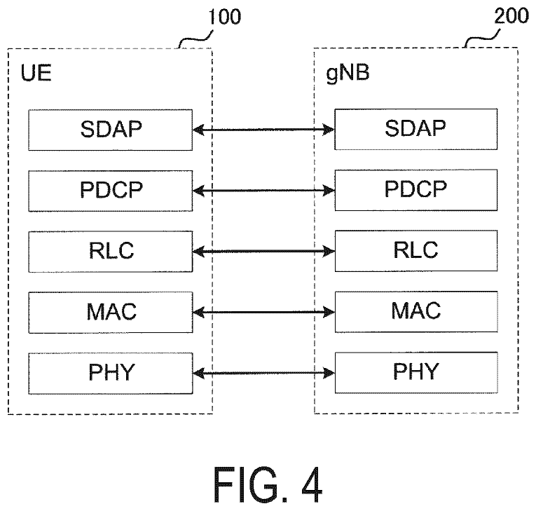

FIG. 4 is a diagram illustrating a configuration example of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through Hybrid Automatic Repeat reQuest (HARQ: Hybrid ARQ), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

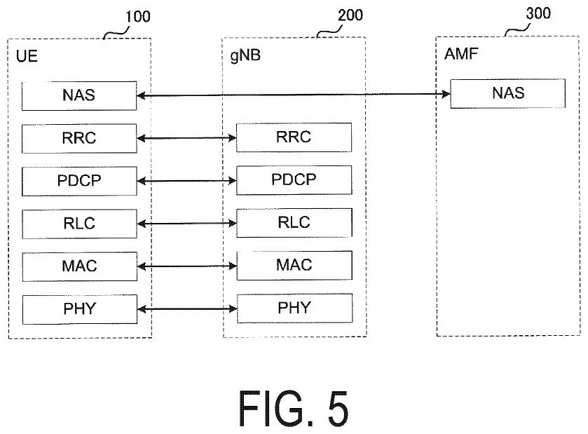

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer other than the protocol of the radio interface. A layer lower than the NAS is referred to as an Access Stratum (AS).

### AI/ML Technology

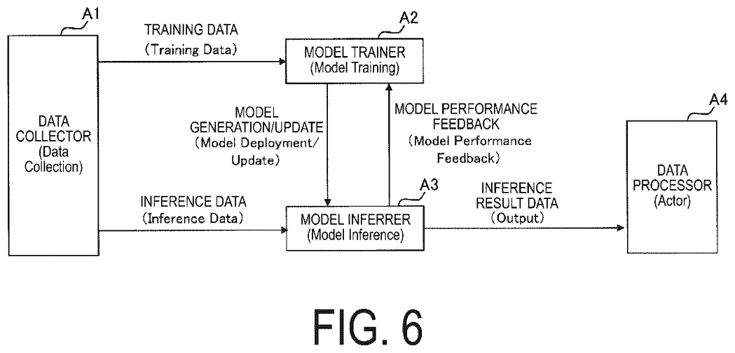

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to the process of collecting data at a network node, a management entity, or the UE 100, for example, to train AI/ML models, perform data analysis, and inference. Based on the data collected by the data collector A1, the training of the AI/ML model and the inference of the AI/ML model in the subsequent stage are performed. The “AI/ML model” is, for example, a data-driven algorithm to which an AI/ML technology is applied to generate a series of outputs based on a series of inputs. Hereinafter, the “model” and the “AI/ML model” may be used interchangeably.

The model trainer A2 performs model training. Specifically, the model trainer A2 optimizes parameters of the training model through machine learning using the training data, and derives (or generates, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. The supervised learning is a method of using correct answer data for the training data. The unsupervised learning is a method of not using correct answer data for the training data. For example, in the unsupervised learning, feature points are learned from a large amount of training data, and correct answer determination (range estimation) is performed. The reinforcement learning is a method of assigning a score to an output result and learning a method of maximizing the score. Although the supervised learning will be described hereinafter, the unsupervised learning may be applied as the machine learning. The reinforcement learning may be applied as the machine learning. In this way, the process of training an AI/ML model (by learning the relationship between input and output) in a data-driven manner and acquiring a trained AI/ML model is called, for example, AI/ML model training. Hereinafter, the “AI/ML model training” may be referred to as a “model training”. The trained AI/ML model may be referred to as a “trained model”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2. This process of using a trained AI/ML model to generate a series of outputs based on a series of inputs is called AI/ML model inference. Hereinafter, the “AI/ML model inference” may be referred to as “model inference”.

The data processor A4 receives the inference result data and performs processing that utilizes the inference result data.

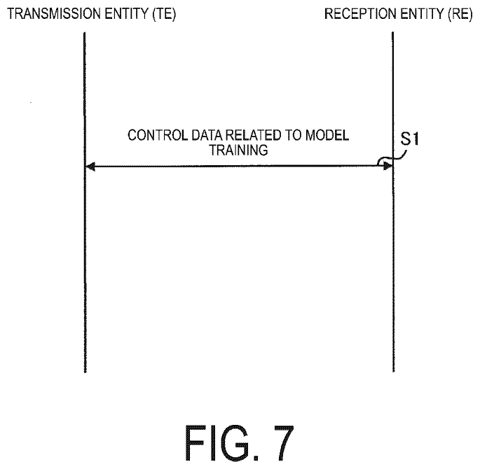

FIG. 7 is a diagram illustrating an operation example in the AI/ML technology according to the first embodiment.

A transmission entity TE is, for example, an entity in which machine learning is performed. The transmission entity TE may derive a trained model by performing machine learning. Then, the transmission entity TE uses the trained model to generate inference result data as an inference result. The transmission entity TE transmits the inference result data to a reception entity RE.

The reception entity RE is, for example, an entity in which no machine learning is performed. The reception entity RE can receive the inference result data transmitted from the transmission entity TE. The reception entity RE performs various processing operations by using the inference result data. The reception entity RE may derive a trained model by performing machine learning. In this case, the reception entity RE transmits the derived trained model to the transmission entity TE.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 7, in step S1, the transmission entity TE transmits to and receives from the reception entity RE control data related to the AI/ML technology. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement”
   Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

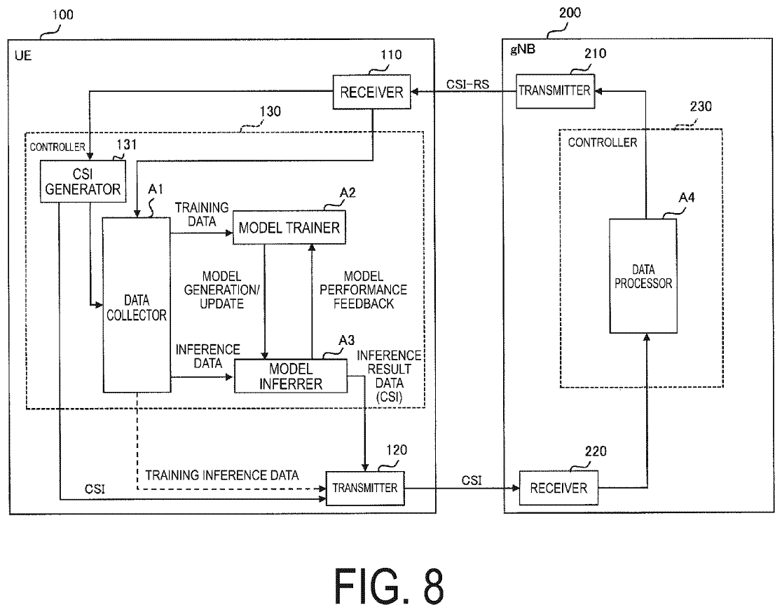

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

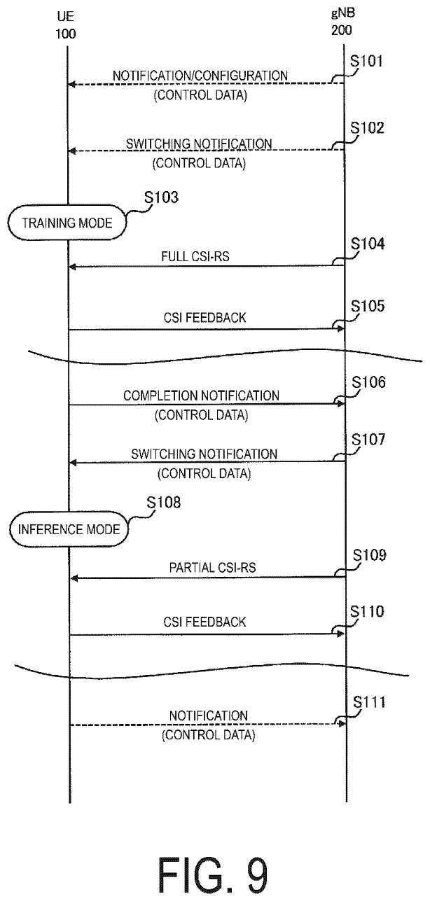

FIG. 9 is a diagram illustrating an operation example in “CSI feedback enhancement” according to the first embodiment.

As illustrated in FIG. 9, in step S101, the gNB 200 may notify or configure the UE 100 of/with a CSI-RS transmission pattern (puncture pattern) in an inference mode as control data. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back), to the gNB 200 as inference result data, the CSI, which is an inference result. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the example illustrated in FIG. 9, an example has been described in which training data are “(full) CSI-RS” and “CSI,” and inference data are “(partial) CSI-RS.” Hereinafter, the training data and/or the inference data may be referred to as a “dataset”.

In the “CSI feedback enhancement”, in addition to the “CSI-RS” and the “CSI”, for example, the following data and/or information may be used as the dataset.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100) What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits, to the UE 100 as the control data, the data type information used as a dataset. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

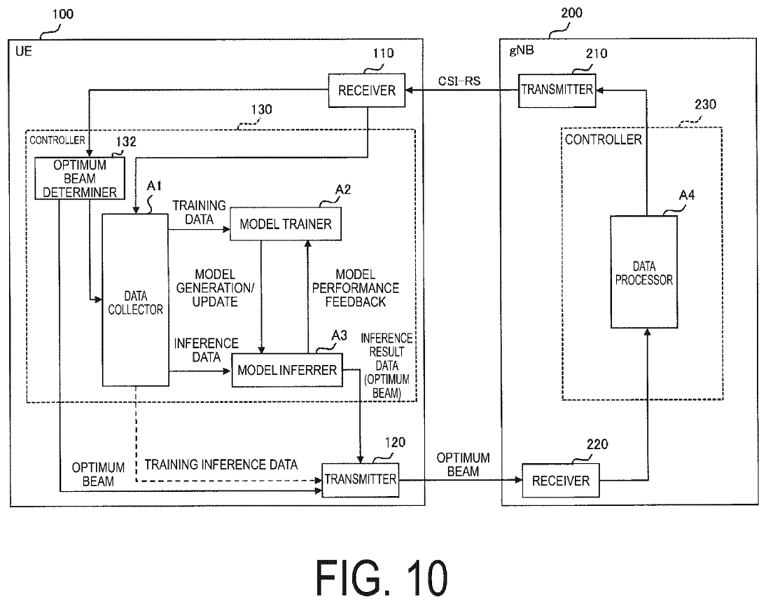

FIG. 10 is a diagram illustrating the arrangement example of functional blocks in “beam management”. In the example of the “beam management” illustrated in FIG. 10, the data collector A1, the model trainer A2, and the model inferrer A3 are included in the controller 130 of the UE 100. On the other hand, the controller 230 of the gNB 200 includes the data processor A4. That is, FIG. 10 illustrates an example in which model training and model inference are performed in the UE 100. In FIG. 10, an example is illustrated in which the transmission entity TE is the UE 100, and the reception entity RE is the gNB 200.

As illustrated in FIG. 10, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing “CSI feedback” with “optimal beam” in FIG. 9.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, the following data and/or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)

The UE 100 may transmit capability information as the control data to the gNB 200, the capability information indicating which type of input data the UE 100 can handle in the machine learning. The capability information may include any information or data from among (Y1) to (Y6). Aside from the training data and the inference data, the capability information may include any information or data from among (Y1) to (Y6). The gNB 200 may transmit, to the UE 100 as the control data, the data type information used as a dataset. The data type information may include, for example, any of the data or information indicated in (Y1) to (Y6). Aside from the training data and the inference data, the data type information may include any information or data from among (Y1) to (Y6).

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

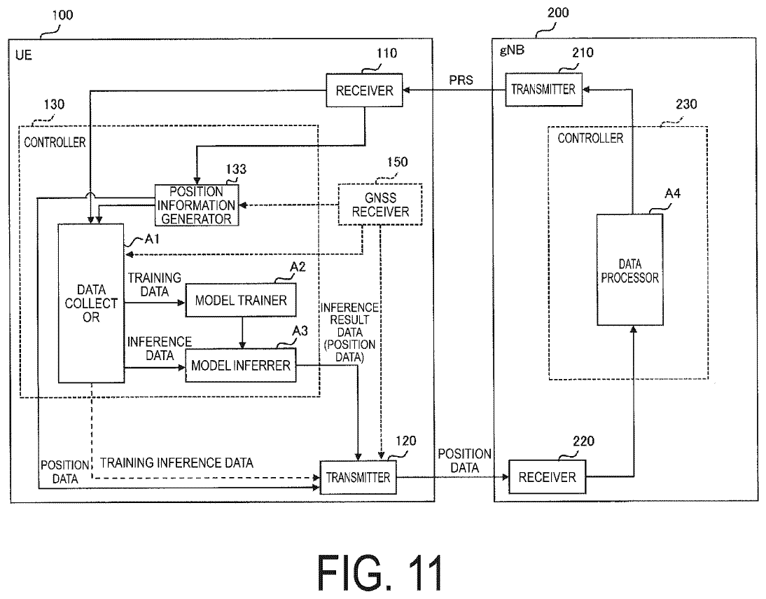

FIG. 11 is a diagram illustrating the arrangement example of functional blocks in the “positioning accuracy enhancement”. In the example of the “positioning accuracy enhancement” illustrated in FIG. 11, the data collector A1, the model trainer A2, and the model inferrer A3 are included in the controller 130 of the UE 100. On the other hand, the controller 230 of the gNB 200 includes the data processor A4. In other words, FIG. 11 illustrates an example in which the UE 100 performs model training and model inference. In FIG. 11, an example in which the transmission entity TE is the UE 100, and the reception entity RE is the gNB 200 is illustrated.

As illustrated in FIG. 11, the UE 100 includes a position information generator 133. The UE 100 may include a Global Navigation Satellite System (GNSS) receiver 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS receiver 150 and generate the position data of the UE 100 based on the GNSS signal.

Note that, as is the case with the full CSI-RS, the gNB 200 transmits the full PRS using a predetermined amount of first resources (for example, all antenna ports or a predetermined amount of time frequency resources). Further, in the same manner as the partial CSI-RS, the gNB 200 transmits a partial PRS using second resources having a smaller resource amount than the first resources (for example, half of the antenna ports in an antenna panel, or half of a predetermined amount of time-frequency resources).

The full GNSS signal may be a GNSS signal temporally continuously received by the GNSS receiver 150. The partial GNSS signal may be a GNSS signal intermittently received by the GNSS receiver 150. In other words, a predetermined amount of first resources may be used for the full GNSS signal, and the second resources the amount of which is smaller than that of the first resources may be used for the partial GNSS signal.

An operation example in the “positioning accuracy enhancement” can be implemented by respectively replacing, in FIG. 9, “full CSI-RS” with “full PRS,” “partial CSI-RS” with “partial PRS,” and “CSI feedback” with the “positioning data.”

In the training mode (step S103), the position information generator 133 generates the position data of the UE 100 based on the full PRS received from the gNB 200. The position information generator 133 may receive a full GNSS signal received by the GNSS receiver 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS receiver 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, the following data and/or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (registered trademark), or Bluetooth (registered trademark)
(Z7) Moving speed of the UE 100 (the moving speed may be measured by the GNSS receiver 150. The moving speed may be measured by a speed sensor in the UE 100) The UE 100 may transmit capability information as the control data to the gNB 200, the capability information indicating which type of input data the UE 100 can handle in the machine learning. The capability information may include any information or data from among (Z1) to (Z7). Aside from the training data and the inference data, the capability information may include any information or data from among (Z1) to (Z7). The gNB 200 may transmit, to the UE 100 as the control data, the data type information used as a dataset. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described next.

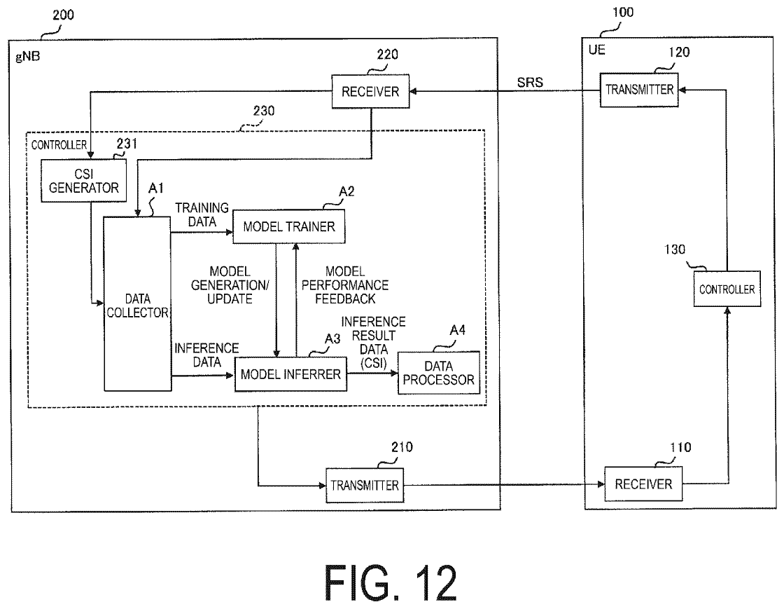

FIG. 12 is a diagram illustrating another arrangement example of “CSI feedback improvement” according to the first embodiment. In FIG. 12, an example in which the data collector A1, the model trainer A2, the model inferrer A3, and the data processor A4 are included in the gNB 200 is illustrated. That is, FIG. 12 illustrates an example in which model training and model inference are performed in the gNB 200. In FIG. 12, an example in which the transmission entity TE is the gNB 200, and the reception entity RE is the UE 100 is illustrated.

In FIG. 12, an example in which AI/ML technology is introduced into CSI estimation performed by the gNB 200 based on a Sounding Reference Signal (SRS) is illustrated. Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

### (1.5) Model Transfer Example

In (1.1) to (1.4), the arrangement example of the functional blocks of the AI/ML technology has been described. Model transfer will be described below. The model to be transferred may be a trained model used in the model inference. The model may be an untrained model used in the model training (or a model being trained).

### (1.5.1) First Operation Pattern Related to Model Transfer

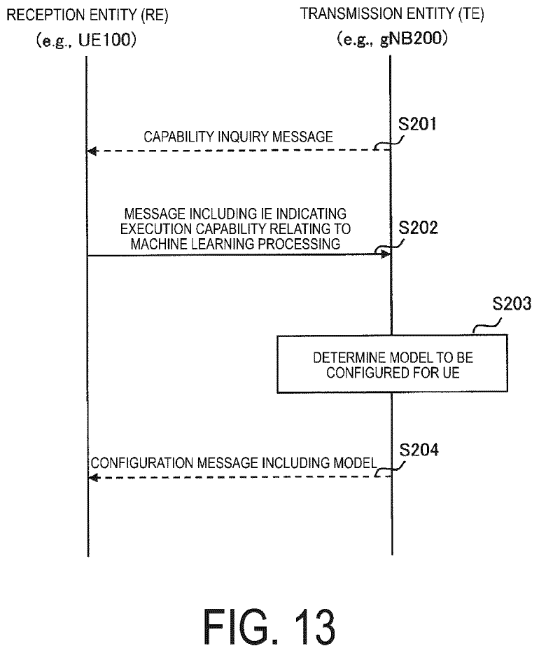

FIG. 13 is a diagram illustrating an operation example of a first operation pattern related to model transfer according to the first embodiment. In the example illustrated in FIG. 13, the description is given on the assumption that the reception entity RE is mainly the UE 100; however, the reception entity RE may be the gNB 200 or the AMF 300. Further, in the example illustrated in FIG. 13, the description is given on the assumption that the transmission entity TE is the gNB 200; however, the transmission entity TE may be the UE 100 or the AMF 300.

As illustrated in FIG. 13, in step S201, the gNB 200 transmits to the UE 100 a capability inquiry message for requesting transmission of a message including an information element (IE) indicating execution capability related to machine learning processing. The UE 100 receives the capability inquiry message. However, the gNB 200 may transmit the capability inquiry message when performing the machine learning processing (when determining to perform the machine learning process).

In step S202, the UE 100 transmits to the gNB 200 a message including an information element indicating execution capability related to machine learning processing (from another viewpoint, an execution environment related to machine learning processing). The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. Alternatively, when a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). As an information element indicating execution capability for inference processing, specifically, an information element indicating whether a deep neural network model is supported may be used. The information element may be an information element indicating the time (response time) required to execute the inference processing.

Alternatively, the information element indicating the execution capability relating to the machine learning processing may be an information element indicating the execution capability of the learning processing (model training). As an information element indicating execution capability for learning processing, specifically, an information element indicating the number of learning processing procedures that can be executed concurrently may be used. The information element may be an information element indicating the processing capacity of the learning processing.

In step S203, the gNB 200 determines a model to be configured (or deployed) in the UE 100 based on the information element included in the message received in step S202.

In step S204, the gNB 200 transmits to the UE 100 a message including the model determined in step S203. The UE 100 receives the message and performs the machine learning processing (i.e., model training processing and/or model inference processing) using the model included in the message. A specific example of step S204 will be described in a second operation pattern below.

### (1.5.2) Second Operation Pattern Related to Model Transfer

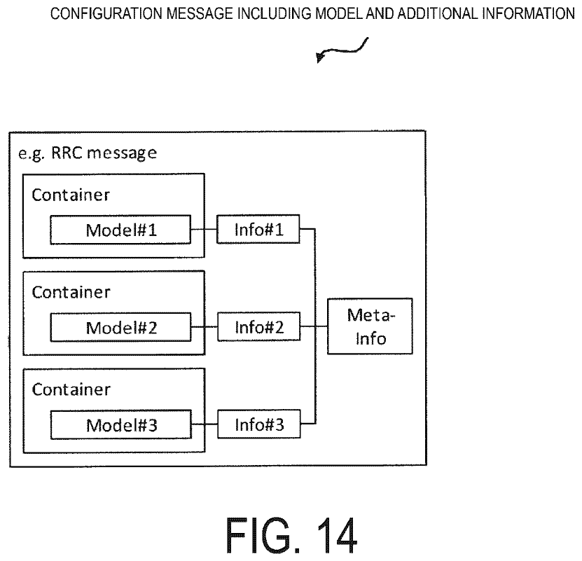

FIG. 14 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 14, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (1.6) Configuration Example of Functional Blocks

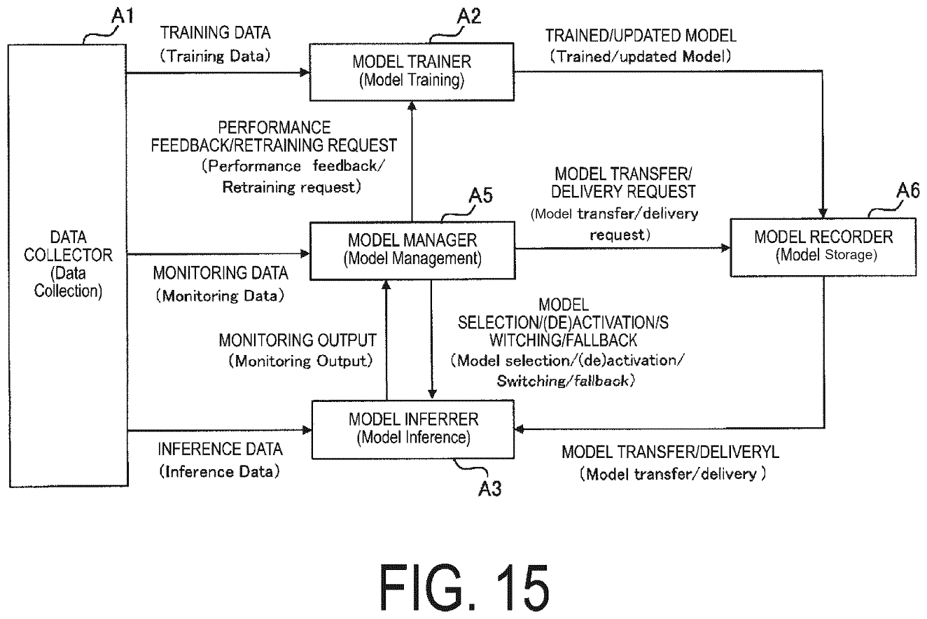

The blocks for AI for wireless communication have been described with reference to FIG. 6. Currently, in 3GPP, a block diagram illustrated in FIG. 15 is being considered for functional blocks for AI for wireless communication.

FIG. 15 is a diagram illustrating a configuration example of functional blocks according to the first embodiment. The functional block diagram illustrated in FIG. 15 further includes a model manager A5 and a model recorder A6, as compared with the functional block diagram illustrated in FIG. 6.

The model manager A5 manages AI/ML models. For example, the model manager A5 may request retraining of a training model from the model trainer A2, or may request model transfer from the model recorder A6. As illustrated in FIG. 15, the AI/ML model that has become trained through retraining may be referred to as an updated model. Further, for example, the model manager A5 may instruct (or request) the model inferrer A3 to perform model selection, (de) activation of a model, model switching, and/or fallback. The model manager A5 may also evaluate performance of a trained model using monitoring data acquired from the data collector A1 and monitoring outputs acquired from the model inferrer A3, and, based on the evaluation result, may request retraining or instruct model switching.

The model recorder A6 functions as a reference point in functional blocks. Therefore, the model recorder A6 does not necessarily record a trained model or an updated model in a recording medium.

Note that how the functional blocks illustrated in FIG. 15 are arranged in each use case is under consideration in 3GPP.

Hereinafter, an AI/ML model to be trained may be referred to as a “training model”, and a trained AI/ML model may be referred to as a “trained model”. Further, the inference data may be referred to as inference data, and the training data may be referred to as training data. Further, when an AI/ML model in the middle of being subjected to model training and a trained AI/ML model are not distinguished from each other, it may simply be referred to as an AI/ML model. As described above, the AI/ML model is, for example, a data-driven algorithm capable of obtaining a series of outputs from a series of inputs by using AI/ML technology.

### Communication Control Method According to First Embodiment

A communication control method according to the first embodiment will be described.

With respect to the AI/ML model, the following points have been agreed in 3GPP. Specifically,
(A1) In an AI/ML model in which inference is performed on the UE 100 side (referred to as UE-side models), functionality-based Life Cycle Management (functionality-based LCM) and model-ID-based life cycle management (model-ID-based LCM) may be performed.
(A2) In addition, also on the UE 100 side of an AI/ML model in which inference is performed on both the UE 100 side and the network side (referred to as two-sided models), functionality-based life cycle management and model-ID-based life cycle management may be performed.

The life cycle management is, for example, management of networks, services, resources, software, and the like from design to termination. The life cycle management may be referred to as LCM below.

Here, with respect to functionality-based LCM and model-ID-based LCM as well, the following agreements exist in 3GPP.
(B1) In functionality-based LCM, the network instructs activation, deactivation, fallback, and switching of functions of an AI/ML model via 3GPP signaling, such as RRC messages, MAC CEs, and DCI. The AI/ML model is identified in the network, and LCM for the AI/ML model may also be performed in the UE 100.
(B2) On the other hand, in model-ID-based LCM, an AI/ML model is identified in the network. Then, the network or the UE 100 can activate, deactivate, select, and switch individual AI/ML models via a model ID.

Thus, in functionality-based LCM (the above (B1)), LCM of an AI/ML model can be performed in the UE 100. Here, a case is assumed in which all LCM of the AI/ML model is caused to be performed in the UE 100. In this case, radio resources may be wastefully consumed when an execution request for an LCM operation is made to a network apparatus every time an operation related to LCM (for example, generation of an AI/ML model or the like) is performed in the UE 100.

In the first embodiment, an object is to suppress consumption of radio resources. In particular, when the LCM for an AI/ML model is performed in the UE 100, an object is to suppress consumption of radio resources by the UE 100.

Here, an example of the LCMs used in the first embodiment will be described. The LCMs used in the first embodiment are summarized in the following table.

TABLE 1
LCM operation

Data collection
Model training
AI/ML Model registration
AI/ML Model deployment
AI/ML Model configuration
AI/ML Model inference operation
AI/ML model selection, AI/ML model activation,
AI/ML model deactivation, AI/ML model switching,
and AI/ML model fallback (Model
selection/activation/deactivation/switching/fallback)
AI/ML Model monitoring
AI/ML Model update
AI/ML Model transfer
UE capability

Each LCM shown in Table 1 is the LCM performed for an AI/ML model in the UE 100. Hereinafter, such LCM may be referred to as an LCM operation. An LCM operation represents an operation performed for an AI/ML model during a period from generation of the AI/ML model (data collection and model learning are also examples of generation of an AI/ML model) to termination of the AI/ML model (although not included in the above table, termination may also be an example of an LCM operation). An LCM operation is also an example of a predetermined operation performed for an AI/ML model. As described above, when LCM operations are performed in the UE 100, radio resources may be wastefully consumed when the UE 100 requests a network apparatus to execute an LCM operation every time the UE 100 performs an LCM operation.

Therefore, in the first embodiment, execution conditions for LCM operations are defined, and the UE 100 is allowed to execute an LCM operation when the execution conditions are satisfied. Specifically, first, a network apparatus (for example, the gNB 200 or the AMF 300) transmits, to a user device (for example, the UE 100), predetermined operation execution conditions (for example, LCM operation execution conditions) indicating execution conditions of a predetermined operation (for example, an LCM operation) for an AI/ML model. Second, when the predetermined operation execution conditions are satisfied, the user device executes the predetermined operation for the AI/ML model without transmitting an execution request of the predetermined operation to the network apparatus. Third, the predetermined operation includes operations for an AI/ML model performed during a period from generation to termination of the AI/ML model.

Thus, in the first embodiment, when the UE 100 satisfies LCM operation execution conditions, the UE 100 executes an LCM operation for an AI/ML model without transmitting an execution request of the LCM operation to a network apparatus. Therefore, since the UE 100 no longer transmits an execution request of an LCM operation to the network apparatus each time the UE 100 executes an LCM operation, consumption of radio resources can be suppressed. Further, since the UE 100 is enabled to execute an LCM operation for an AI/ML model on the condition that the LCM operation execution conditions are satisfied, it is also possible to ensure reliability of the LCM operation as compared with a case where the LCM operation is executed unconditionally.

A network apparatus refers to, for example, a device included in an NG-RAN 10 and a core network 20. Specifically, the network apparatus is, for example, the gNB 200, the AMF 300, or a Location Management Function (LMF). Hereinafter, the network apparatus and a network (NW) may be used without being distinguished from each other.

### Operation Example According to First Embodiment

Next, an operation example according to the first embodiment will be described.

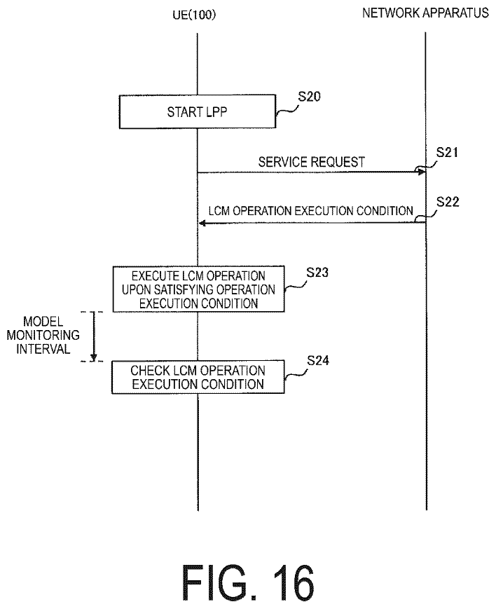

FIG. 16 is a diagram illustrating an operation example according to the first embodiment. In FIG. 16, a use case of “positioning accuracy enhancement” is used. Further, FIG. 16 illustrates an example of the UE-side model (that is, a model in which inference is performed in the UE 100). FIG. 16 illustrates an example in which a transmission entity is the UE 100 and a reception entity is a network apparatus.

As illustrated in FIG. 16, in step S20, the UE 100 starts execution of an LTE Positioning Protocol (LPP). The LPP is a position information acquisition protocol (or position information acquisition procedure) based on the LTE. The UE 100 performs acquisition of position information using the LPP. The UE 100 may start an acquisition operation of the position information using the NR Positioning Protocol (NPP) instead of the LPP.

In step S21, the UE 100 makes a service request using the LPP to a network apparatus. Specifically, the transmitter 120 of the UE 100 transmits a service request message to the network apparatus. For example, the UE 100 may transmit a service request message requesting an LPP service to an LMF. The UE 100 may transmit a service request message to an LPP server instead of the LMF. Alternatively, the UE 100 may make a service request to the LMF using an NPP message based on an NPP protocol.

In step S22, the network apparatus transmits LCM operation execution conditions to the UE 100. When the network apparatus is a gNB 200, a transmitter 210 of the gNB 200 may transmit an RRC message (or a MAC CE) including the LCM operation execution conditions to the UE 100. In this case, the gNB 200 may transmit an RRC message including the LCM operation execution conditions to the UE 100 in response to receiving, from an LMF, a message indicating that a service request has been received from the UE 100 (for example, a message based on an NRPPa protocol). Further, when the network apparatus is an AMF 300, a transmitter of the AMF 300 may transmit a NAS message including the LCM operation execution conditions to the UE 100. In this case, the AMF 300 may transmit the NAS message including the LCM operation execution conditions to the UE 100 in response to receiving, from the LMF, a message indicating that a service request has been received from the UE 100 (for example, a message based on an NL1 protocol). Further, when the network apparatus is the LMF (or the LPP server), a transmitter of the LMF (or a transmitter of the LPP server) may transmit an LPP message or an NPP message including the LCM operation execution conditions to the UE 100. Further, when the network apparatus is an OTT server, a transmitter of the OTT server may transmit a message that is based on a predetermined protocol and includes the LCM operation execution conditions to the UE 100. In this case, the OTT server may transmit a message including the LCM operation execution conditions to the UE 100 in response to receiving, from the LMF, a message indicating that a service request has been received from the UE 100. The receiver 110 of the UE 100 receives the LCM operation execution conditions.

First, the LCM operation execution conditions may be that a difference (or an error) between position information acquired by the UE 100 using the LPP and position information output (or inferred) from the trained AI/ML model is equal to or less than a threshold value “x” m. That is, when position information acquired using the LPP is set as a correct value, and an error between the position information output from the trained AI/ML model and the correct value is equal to or less than the threshold value “x” m, the LCM operation may be executed. A unit of the threshold value may be “%” instead of “m”.

Here, an indicator used for the LCM operation execution conditions is referred to as a Key Performance Indicator (KPI: major performance indicator). In this example, a target of the KPI is position information. The target of the KPI may be included in the LCM operation execution conditions. The target may be separate from the LCM operation execution conditions. In the latter case, the LCM operation execution conditions and the KPI may be included in one message and transmitted to the UE 100. Hereinafter, the target of the KPI is described as being included in the LCM operation execution conditions. In the above example, the target of the KPI is position information, and the LCM operation execution conditions are that an error of the position information is equal to or less than “x” m (or equal to or less than “x” %).

Second, the LCM operation execution conditions may be that a difference (or an error) between assist information acquired by the UE 100 using the LPP and assist information output from the trained AI/ML model is equal to or less than a threshold value “y”. The assist information is information used when acquiring position information. Specifically, the assist information may be an angle of arrival (AoA) of the UE 100 as viewed from a network. In this case, a unit of the threshold value “y” is an angle. Further, the assist information may be a flag or a numerical value used in Line Of Sight (LOS) or Non-LOS (NLOS). When the numerical value is expressed in “dB”, a unit of the threshold value “y” is also expressed in “dB”. In this case, a target of the KPI is assist information, and the LCM operation execution conditions are that an error of the assist information is equal to or less than “x”.

Third, the LCM operation execution conditions may be that acquisition of position information using the LMF is performed at predetermined time intervals. That is, the UE 100 acquires position information from the LMF at each predetermined time interval, and at times other than the predetermined time intervals, the UE 100 executes the LCM operation for the AI/ML model. In this case, a target of the KPI is position information, and the LCM operation execution conditions are that acquisition of position information using the LMF is performed at predetermined time intervals.

In FIG. 16, since a use case of “positioning accuracy enhancement” is used, description is given using information related to position information; however, in use cases of “CSI feedback” or “beam management”, different information is used. The targets of the KPI and the LCM operation execution conditions in each use case are summarized in the following table.

TABLE 2

| | | Example of LCM | |
|---|---|---|---|
| | | operation execution | |
| Use case type | KPI target | condition | Remarks |
| Positioning | Position | An error of position | |
| accuracy | information | information is equal to | |
| enhancement | | or less than “x” m (or | |
| | | equal to or less than | |
| | | “x” %). | |
| Positioning | Assist | An error of assist | |
| accuracy | information | information is equal to | |
| enhancement | | or less than “y”. | |
| Positioning | Position | Acquisition of | An LPP server may be used |
| accuracy | information | position information | instead of the LMF. |
| enhancement | | using the LMF is | |
| | | performed at | |
| | | predetermined time | |
| | | intervals. | |
| CSI feedback | Channel | An error of channel | Channel estimation |
| enhancement | estimation | estimation | information (transfer function, |
| | | | SNR, or CQI, etc.) output by |
| | | | the CSI generator 131 is |
| | | | compared with channel |
| | | | estimation information |
| | | | inferred by the trained AI/ML |
| | | | model. |
| Beam | RSRP | An error of RSRP is | |
| management | | “x” % (or “x” dB). | |
| Common | Current | The current position is | The current position may be |
| | position | within a specific | longitude and latitude, or a |
| | (geographical | position range (for | height from the ground. |
| | condition) | example, | |
| | | underground, a | |
| | | specific area, etc.). | |
| Common | Time | An AI/ML model is | |
| | (temporal | used within a | |
| | condition) | predetermined time | |
| | | period. | |
| Common | Current | Camping on a specific | Deployment condition |
| | position | TAC or cell ID. | |
| | (TAC or cell | | |
| | ID, etc.) | | |
| Common | Current | A current position of | The specific environment |
| | position | the UE 100 is a | includes an indoor hotspot, an |
| | (channel | specific environment | urban macro, a dense urban, a |
| | model) | (such as an indoor | rural area, etc. Channel model. |
| | | hotspot). | |
| Common | UE 100 side | An AI/ML model is | |
| | conditions | used when the | |
| | Reception | reception quality is | |
| | quality | equal to or less than | |
| | (electric field | “z”. | |
| | strength, | An AI/ML model is | |
| | SINR, etc.) | used when the moving | |
| | Moving | speed exceeds “u” km. | |
| | speed | An AI/ML model is | |
| | Power | used when the power | |
| | consumption | consumption (or heat | |
| | (or heat | dissipation level) is | |
| | dissipation | equal to or less than | |
| | level) | “w”. | |

As shown in Table 2 above, in examples of the LCM operation execution conditions that include an error, determination is performed by comparing a measured value actually measured with an inference result of an AI/ML model. On the other hand, in examples of the LCM operation execution conditions that do not include an error, whether the conditions are satisfied is determined, for example, without using an AI/ML model.

Fourth, the LCM operation execution conditions may include, in the UE 100, a monitoring interval (Model monitoring interval) for repeatedly monitoring the AI/ML model. The UE 100 checks, at each monitoring interval, whether the trained AI/ML model satisfies the LCM operation execution conditions.

In step S23, the UE 100 checks, based on the LCM operation execution conditions, whether a currently used trained AI/ML model satisfies the LCM operation execution conditions. For example, when the LCM operation execution conditions are that an error of position information is equal to or less than a threshold value “x” m (or equal to or less than “x”%), the controller 130 of the UE 100 compares position information received from the LMF with position information inferred from the trained AI/ML model, and when a difference therebetween is equal to or less than “x” m, may determine that the trained AI/ML model satisfies the LCM operation execution conditions. Further, for example, when the LCM operation execution conditions are that an error of assist information is equal to or less than a threshold value “x”, the controller 130 of the UE 100 compares assist information received from the LMF with assist information inferred from the trained model, and when a difference therebetween is equal to or less than “y” and this continues for “n” consecutive times, may determine that the trained AI/ML model satisfies the LCM operation execution conditions. Further, for example, when the LCM operation execution conditions are that acquisition of position information using the LMF is performed at predetermined time intervals, the controller 130 of the UE 100 may determine that the trained AI/ML model satisfies the LCM operation execution conditions when a predetermined time has not elapsed since acquisition of position information using the LMF. When the controller 130 of the UE 100 holds a plurality of trained AI/ML models, the controller 130 may determine whether each trained AI/ML model satisfies the LCM operation execution conditions. The threshold values or numerical values used for the LCM operation execution conditions (such as a threshold value “x”, a difference “y”, and a number of times “n”) may be included in the LCM operation execution conditions and transmitted from the network apparatus to the UE 100 (step S22).

When the controller 130 of the UE 100 determines that the LCM operation execution conditions are satisfied, the controller 130 executes the LCM operation without transmitting an execution request for the LCM operation to the network apparatus.

First, when the controller 130 of the UE 100 determines that the LCM operation execution conditions are satisfied, the controller 130 performs activation (Model Activation) of the trained AI/ML model. The activation is an example of the LCM operation. However, when the trained AI/ML model is already in use, the controller 130 regards the trained AI/ML model as being activated and continues use of the trained AI/ML model. On the other hand, when the trained AI/ML model already in use exists and another trained AI/ML model (which is unused and in a deactivated state) having higher accuracy than the trained AI/ML model exists, the controller 130 performs switching to the other trained AI/ML model. The switching of the model may be switching from the trained AI/ML model to the other trained AI/ML model. The switching may be performed by deactivating the currently used trained AI/ML model and activating the other trained AI/ML model.

The above-described operation related to activation may be performed when permission is given in advance from the network apparatus. That is, when the transmitter 120 of the UE 100 determines, in the controller 130, that the LCM operation execution conditions are satisfied, the transmitter 120 may transmit, to the network apparatus, information indicating that there exists a trained AI/ML model that satisfies the LCM operation execution conditions. The information may be represented by a list of model IDs of a plurality of trained AI/ML models that satisfy the LCM operation execution conditions. The list may include information on accuracy for each trained AI/ML model related to the LCM operation execution conditions.

A controller of the network apparatus may select an appropriate trained AI/ML model with reference to the list, and a transmitter of the network apparatus may transmit, to the UE 100, instruction information indicating activation of the selected trained AI/ML model. In the UE 100, the trained AI/ML model selected by the network apparatus is activated in accordance with the instruction information.

Second, when the controller 130 of the UE 100 does not hold a trained AI/ML model that satisfies the LCM operation execution conditions, the controller 130 requests model update (Model Update) or model transfer (Model Transfer) from the network apparatus. The model update and the model transfer are also examples of the LCM operation. The controller 130 may request model transfer from the network apparatus when detecting that a currently used trained AI/ML model does not satisfy the LCM operation execution conditions. When requesting model transfer, the controller 130 may transmit, to the network apparatus, information indicating an available capacity of a memory inside the UE 100.

Note that the controller 130 (or the transmitter 120) may transmit, to the network apparatus, information indicating any one of that a model satisfying the LCM operation execution conditions is not held, that none of models held by the UE 100 satisfies the LCM operation execution conditions, and that a currently used model does not satisfy the LCM operation execution conditions. The information may include a model ID and/or a function ID to which a model is applied. The information may include accuracy information of each model. Based on the information, the network apparatus may determine whether to perform trained AI/ML model transfer or to use a legacy operation without using the model. Based on the determination result, the network apparatus can transmit, to the UE 100, instruction information indicating performing the model transfer or instructing to perform the legacy operation.

Third, when the controller 130 of the UE 100 determines that a currently used trained AI/ML model does not satisfy the LCM operation execution conditions, and holds a trained AI/ML model that satisfies the LCM operation execution conditions, but the trained AI/ML model is in model deactivation, the controller 130 performs model switching. Alternatively, when there exists an AI/ML model having higher accuracy than the currently used trained AI/ML model, the controller 130 (or the transmitter 120) of the UE 100 may transmit, to the network apparatus, information indicating that the AI/ML model exists. The information may represent a preference for switching between AI/ML models. The information may include a model ID of the AI/ML model. The controller 130 of the UE 100 may activate the trained model after model switching. The model switching is also an example of the LCM operation.

Fourth, when the controller 130 of the UE 100 does not hold the trained AI/ML model that satisfies the LCM operation execution conditions, and the network apparatus also does not hold the trained AI/ML model that satisfies the LCM operation execution conditions, model training is performed for the AI/ML model held by the UE 100 or the AI/ML model held by the network apparatus. Alternatively, the controller 130 of the UE 100 may perform fallback instead of model training. The fallback is an operation of acquiring position information (or CSI, or an optimal beam) without using an AI/ML model. The operation is referred to as a legacy operation. For example, acquisition of position information using the LMF, or acquisition of position information using the GNSS receiver 150, is an example of the legacy operation. The model training and the fallback are examples of the LCM operation.

After performing the LCM operation, the controller 130 of the UE 100 acquires position information using the trained AI/ML model.

In step S24, when a model monitoring interval arrives, the UE 100 checks whether a currently used trained AI/ML model satisfies the LCM operation execution conditions. The controller 130 of the UE 100 may determine whether the LCM operation execution conditions are satisfied, in the same manner as in step S23. For example, when the controller 130 of the UE 100 determines that the currently used trained AI/ML model satisfies the LCM operation execution conditions, the controller 130 may continue to use the trained AI/ML model. On the other hand, for example, when the controller 130 of the UE 100 determines that the currently used trained AI/ML model does not satisfy the LCM operation execution conditions, the controller 130 may request, from the network apparatus, whether execution of the LCM operation is permitted. The UE 100 may request whether execution of the LCM operation is permitted by using a MAC CE, an RRC message, a NAS message, an LPP message, an NPP message, or a predetermined message.

The UE 100 may perform the LCM operation in the following cases without performing determination of the LCM operation execution conditions at the model monitoring interval.
(C1) Since the UE 100 has moved from underground to above ground, use of the GNSS receiver 150 has become possible.
(C2) Although a radio wave condition of the UE 100 was less than a certain level and communication with the LMF was difficult, communication with the LMF has become sufficiently possible.

For example, the controller 130 of the UE 100 may check a reception level of the GNSS receiver 150, and may determine that use of the GNSS receiver 150 has become possible when the reception level becomes equal to or higher than a predetermined level (the above (C1)). Further, for example, the controller 130 of the UE 100 may determine that communication with the LMF has become sufficiently possible when reception quality of a received signal becomes equal to or higher than a predetermined quality and it is checked that the received signal is a signal from the LMF (the above (C2)).

There may be a case where the LCM operation execution conditions are satisfied within a predetermined time from acquisition of position information using the LMF to the next acquisition of position information using the LMF. However, in such a case, for example, the UE 100 waits for the predetermined time. Accordingly, the UE 100 may execute the LCM operation by satisfying the LCM operation execution conditions without waiting until the next predetermined time (that is, without waiting for acquisition of position information using the LMF at the next predetermined time). Alternatively, the UE 100 may check execution of the LCM operation with the network apparatus without waiting until the next predetermined time. Information indicating which is to be performed, that is, whether to execute the LCM operation without waiting for the predetermined time or to check execution of the LCM operation without waiting for the predetermined time, may be included in the LCM operation execution conditions (step S22). Execution check of the LCM operation may be performed, for example, as follows. That is, the UE 100 transmits, to the network apparatus, information indicating that the LCM operation execution conditions are satisfied. In response to receiving the information, the network apparatus transmits, to the UE 100, information instructing (or permitting) execution of the LCM operation. The UE 100 may execute the LCM operation for the trained AI/ML model that satisfies the LCM operation execution conditions in accordance with the information.

### Another Operation Example 1 According to First Embodiment

In step S23, when executing the LCM operation, the UE 100 may request, from the network apparatus, execution permission indicating whether the UE 100 may execute the LCM operation. For example, the transmitter 120 of the UE 100 may transmit, to the network apparatus, a request for permission to execute a fallback operation. The transmitter 120 may transmit, to the network apparatus, a MAC CE, an RRC message, a NAS message, an LPP message, an NPP message, or a predetermined message including the request. A receiver of the network apparatus receives the request. In the network apparatus, in response to receiving the request, whether execution of the LCM operation is permitted may be determined, and a determination result may be transmitted to the UE 100. A transmitter of the network apparatus transmits, to the UE 100, a MAC CE, an RRC message, a NAS message, an LPP message, an NPP message, or a predetermined message including the determination result. The receiver 110 of the UE 100 receives the request. The controller 130 of the UE 100 may execute the LCM operation in accordance with the determination result.

### Another Operation Example 2 According to First Embodiment

In step S23, when the UE 100 determines that the LCM operation execution conditions are satisfied, the UE 100 may transmit, to the network apparatus, information indicating that the LCM operation execution conditions are satisfied. In this case, the UE 100 does not need to execute the LCM operation. By receiving the information, the network apparatus can recognize that the UE 100 satisfies the LCM operation execution conditions but has not executed the LCM operation. In response to receiving the information, the network apparatus may instruct the UE 100 to execute the LCM operation. Transmission of the information may be performed between the transmitter 120 of the UE 100 and a receiver of the network apparatus by using a MAC CE, an RRC message, a NAS message, an LPP message, an NPP message, or a predetermined message. Further, the execution instruction of the LCM operation may also be performed between a transmitter of the network apparatus and the receiver 110 of the UE 100 by using a MAC CE, an RRC message, a NAS message, an LPP message, an NPP message, or a predetermined message.

### Second Embodiment

A second embodiment will be described. The second embodiment will be mainly described in terms of differences from the first embodiment.

In the first embodiment, an example has been described in which the UE 100 executes an LCM operation without transmitting an execution request for the LCM operation to the network apparatus. In this case, in the network apparatus, there may be a case where it is not possible to ascertain what kind of the LCM operation is being performed in the UE 100. On the other hand, when the UE 100 reports execution of the LCM operation to the network apparatus each time the UE 100 executes the LCM operation, there may be a case where radio resources are consumed beyond a certain level.

Therefore, in a second embodiment, the UE 100 stores LCM operation contents as a log, and thereafter transmits the stored LCM operation contents to the network apparatus. Specifically, first, when the user equipment (for example, the UE 100) performs a predetermined operation (for example, an LCM operation) on an AI/ML model, contents related to the predetermined operation are stored in a memory as a log. Second, the user equipment transmits the contents related to the predetermined operation to the network apparatus.

Accordingly, for example, in the UE 100, after LCM operation contents are stored, the LCM operation contents can be collectively reported to the network apparatus, and thus, compared with a case where the LCM operation contents are reported to the network apparatus each time the LCM operation is performed, consumption of radio resources can be suppressed.

### Operation Example According to Second Embodiment

Next, an operation example according to the second embodiment will be described.

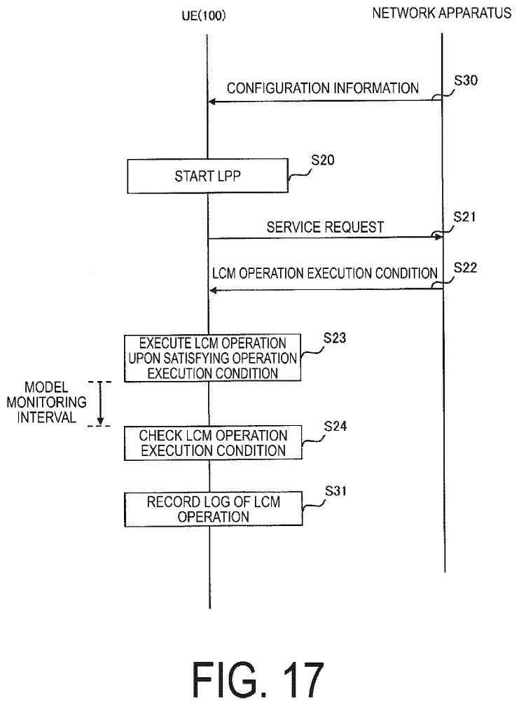

FIG. 17 is a diagram illustrating an operation example according to the second embodiment. In FIG. 17, the same processing as that of the first embodiment (FIG. 16) is assigned the same reference numerals. Before the operation of FIG. 17 is started, the UE 100 is assumed to be in an RRC connected state with respect to the network.

In step S30, the network apparatus transmits, to the UE 100, configuration information related to content reporting of the LCM operation. For example, the transmitter 210 of the gNB 200 may transmit an RRC message including the configuration information to the UE 100.

Alternatively, the transmitter 210 may transmit control data including the configuration information to the UE 100.

First, the configuration information may include an instruction indicating whether LCM operation contents are to be reported immediately, or whether the LCM operation contents are to be stored in a memory as a log and thereafter reported. When immediate reporting is performed, the UE 100 may report the LCM operation contents to the gNB 200 each time the UE 100 executes the LCM operation. The UE 100 may complete acquisition and reporting of the LCM operation contents while the UE 100 is in an RRC connected state. In this case, the configuration information may be included in an existing measurement configuration (MeasConfig). On the other hand, when the contents are stored as a log, the UE 100 stores the LCM operation contents in a memory as a log each time the UE 100 executes the LCM operation, and reports the LCM operation contents to the gNB 200 based on an instructed timing included in the configuration information. The UE 100 may store the LCM operation content as a log when the UE 100 is in an RRC idle state (or an RRC inactive state), and may report the stored LCM operation contents to the gNB 200 when the UE 100 enters an RRC connected state. In this case, the configuration information may be included in a logged measurement configuration (LoggedMeasurementConfiguration) message. Hereinafter, description is given assuming that the configuration information includes an instruction to store the LCM operation contents as a log and thereafter report the LCM operation contents.

Second, the configuration information may include an instruction indicating LCM operation contents to be reported. For example, the configuration information may include an instruction indicating that LCM operation contents itself (such as activation, fallback, etc.) are to be reported. Alternatively, the configuration information may include an instruction indicating that a factor that caused execution of the LCM operation (for example, that an error of position information was equal to or less than “x” m) is to be reported. Alternatively, the configuration information may include an instruction indicating that a model ID or a model name of an AI/ML model that is a target of execution of the LCM operation is to be reported. Alternatively, the configuration information may include an instruction indicating that a function name of an AI/ML model that is a target of execution of the LCM operation is to be reported.

Third, the configuration information may include an instruction indicating a timing to report is to be performed. The timing to report may be indicated by time information. Alternatively, a timing to be reported may be indicated by a condition. The condition may be, for example, when the UE 100 transitions to an RRC connected state. The condition may be when reception quality for a serving cell is equal to or higher than a predetermined quality. When the UE 100 satisfies the condition, the UE 100 may report LCM operation contents stored in the memory to the gNB 200.

The receiver 110 of the UE 100 receives the configuration information, and the controller 130 of the UE 100 sets the configuration information in the UE 100.

Step S20 to step S24 are the same as those of the first embodiment.

In step S31, the UE 100 stores the LCM operation content in a memory as a log. The UE 100 may store the LCM operation content as a log in accordance with the configuration information (step S30). For example, the controller 130 of the UE 100 may store the LCM operation execution conditions as the LCM operation contents. Alternatively, the controller 130 of the UE 100 may store the LCM operation itself (for example, activation or fallback) as the LCM operation contents. Alternatively, the controller 130 of the UE 100 may store a factor that caused execution of the LCM operation (for example, that an error of position information was equal to or less than “x” m) as the LCM operation contents. The controller 130 of the UE 100 may store a time (or a timestamp) at which the LCM operation was performed, together with the LCM operation contents. Alternatively, the controller 130 of the UE 100 may store position information at a time when the LCM operation was performed, together with the LCM operation contents. Alternatively, the controller 130 of the UE 100 may store a model ID or a model name of an AI/ML model for which the LCM operation was performed, as the LCM operation contents. Alternatively, the controller 130 of the UE 100 may store a function name of an AI/ML model for which the LCM operation was performed. The controller 130 of the UE 100 may store the LCM operation contents and the like in the memory when the UE 100 is in an RRC idle state or an RRC inactive state.

The transmitter 120 of the UE 100 may transmit the LCM operation contents and the like to the gNB 200 at a timing instructed by the configuration information (or when a condition is satisfied). For example, the transmitter 120 may transmit the LCM operation contents and the like at an instructed time. Alternatively, when the UE 100 transitions to an RRC connected state (from an RRC idle state or an RRC inactive state), the transmitter 120 may transmit the contents of the LCM operation and the like by regarding that a condition included in the configuration information is satisfied. Alternatively, in response to a request from the network apparatus, the transmitter 120 may transmit the stored contents of the LCM operation to the network apparatus.

In FIG. 17, the operation of step S31 is performed after step S24; however, the operation of step S31 is performed each time the LCM operation is performed in the UE 100.

### Other Embodiments

In the first embodiment and the second embodiment described above, supervised learning has been mainly described; however, the present disclosure is not limited thereto. For example, the unsupervised learning or the reinforcement learning may be applied to the first embodiment.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each processing performed by the UE 100, the gNB 200, or the network apparatus may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Further, circuits for executing respective processing performed by the UE 100, the gNB 200, or the network apparatus may be integrated, and at least a part of the UE 100, the gNB 200, or the network apparatus may be configured as a semiconductor integrated circuit (a chipset, a System on a Chip (SoC)).

Functions implemented by the UE 100, the gNB 200, or the network apparatus may be implemented in circuitry or processing circuitry including a general-purpose processor, a special-purpose processor, an integrated circuit, application specific integrated circuits (ASICs), a central processing unit (CPU), conventional circuits, and/or a combination thereof, which are programmed to implement the described functions. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### SUPPLEMENTARY NOTES

### Supplementary Note 1

A communication control method in a mobile communication system, the communication control method including the steps of:
transmitting, by a network apparatus to a user equipment, a predetermined operation execution condition indicating an execution condition of a predetermined operation for an AI/ML model; and
executing, by the user equipment, the predetermined operation for the AI/ML model without transmitting an execution request for the predetermined operation to the network apparatus, when the predetermined operation execution condition is satisfied,
in which the predetermined operation includes an operation for the AI/ML model that is performed during a period from generation of the AI/ML model to termination thereof.

### Supplementary Note 2

The communication control method according to Supplementary Note 1, in which the predetermined operation includes an operation that is performed as life cycle management of the AI/ML model.

### Supplementary Note 3

The communication control method according to Supplementary Note 1 or 2, in which the predetermined operation includes at least one operation selected from the group consisting of transfer of the AI/ML model, selection of the AI/ML model, activation of the AI/ML model, deactivation of the AI/ML model, fallback of the AI/ML model, and switching of the AI/ML model.

### Supplementary Note 4

The communication control method according to any one of Supplementary Note 1 to 3, further including the steps of:
storing, by the user equipment in a memory, content relating to the predetermined operation as a log, when performing the predetermined operation for the AI/ML model; and
transmitting, by the user equipment, the content relating to the predetermined operation to the network apparatus.

### Supplementary Note 5

A network apparatus in a mobile communication system, the apparatus including: a transmitter configured to transmit, to a user equipment, a predetermined operation execution condition indicating an execution condition of a predetermined operation for an AI/ML model, wherein, in the user equipment, the predetermined operation for the AI/ML model is executed without transmitting an execution request for the predetermined operation to the network apparatus, when the predetermined operation execution condition is satisfied, and the predetermined operation includes an operation performed by the user equipment for the AI/ML model during a period from generation of the AI/ML model to termination thereof.

### Supplementary Note 6

A user equipment in a mobile communication system, the equipment including:
a receiver configured to receive, from a network apparatus, a predetermined operation execution condition indicating an execution condition of a predetermined operation for an AI/ML model; and
a controller configured to execute the predetermined operation for the AI/ML model without transmitting an execution request for the predetermined operation to the network apparatus, when the predetermined operation execution condition is satisfied,
in which the predetermined operation includes an operation for the AI/ML model that is performed during a period from generation of the AI/ML model to termination thereof.

### REFERENCE SIGNS

1: Mobile communication system
20: 5GC (CN)
100: UE
110: Receiver
120: Transmitter
130: Controller
200: gNB
210: Transmitter
220: Receiver
230: Controller

1. A communication control method in a mobile communication system, the communication control method comprising:
transmitting, by a network apparatus to a user equipment, a predetermined operation execution condition indicating an execution condition of a predetermined operation for an Artificial Intelligence (AI)/Machine Learning (ML) model; and
executing, by the user equipment, the predetermined operation for the AI/ML model without transmitting an execution request for the predetermined operation to the network apparatus, when the predetermined operation execution condition is satisfied,
wherein the predetermined operation comprises an operation for the AI/ML model that is performed during a period from generation of the AI/ML model to termination thereof.

2. The communication control method according to claim 1, wherein
the predetermined operation comprises an operation that is performed as life cycle management of the AI/ML model.

3. The communication control method according to claim 1, wherein
the predetermined operation comprises at least one operation selected from the group consisting of transfer of the AI/ML model, selection of the AI/ML model, activation of the AI/ML model, deactivation of the AI/ML model, fallback of the AI/ML model, and switching of the AI/ML model.

4. The communication control method according to claim 1, further comprising:
storing, by the user equipment in a memory, content relating to the predetermined operation as a log, when performing the predetermined operation for the AI/ML model; and
transmitting, by the user equipment, the content relating to the predetermined operation to the network apparatus.

5. A network apparatus in a mobile communication system, the apparatus comprising:
a transmitter configured to transmit, to a user equipment, a predetermined operation execution condition indicating an execution condition of a predetermined operation for an AI/ML model,
wherein, in the user equipment, the predetermined operation for the AI/ML model is executed without transmitting an execution request for the predetermined operation to the network apparatus, when the predetermined operation execution condition is satisfied, and
the predetermined operation comprises an operation performed by the user equipment for the AI/ML model during a period from generation of the AI/ML model to termination thereof.

6. A user equipment in a mobile communication system, the equipment comprising:
a receiver configured to receive, from a network apparatus, a predetermined operation execution condition indicating an execution condition of a predetermined operation for an AI/ML model; and
a controller configured to execute the predetermined operation for the AI/ML model without transmitting an execution request for the predetermined operation to the network apparatus, when the predetermined operation execution condition is satisfied,
wherein the predetermined operation comprises an operation for the AI/ML model that is performed during a period from generation of the AI/ML model to termination thereof.
